(19) United States
(12) Patent Application Publication
(10) Pub. No.: US 2006/0161567 A1
(43) Pub. Date: Jul. 20, 2006

(54) Low communication complexity memory-bound function

(75) Inventors: Cynthia Dwork, San Francisco, CA (US); Moni Naor, Tel-Aviv (IL)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/036,873

(22) Filed: Jan. 14, 2005

(51) Int. Cl. G06F 17/24

(52) U.S. Cl. 707/101

(57) ABSTRACT

Reducing or deterring undesirable electronic communications by requiring a sender of an electronic communication to download a memory-bound function that describes a table. The function initializes and builds a table, hashes each entry in the table, sorts the table. The steps of hashing and sorting the table may be completed as many times as desired. At the conclusion of the iterations, the table may be hashed a final time to unsort the table. The sender then uses the table in proving a computational function. The proof of the function is sent to a recipient of the electronic communication as proof that the sender has spent computational effort to send the e-mail.

### FIELD OF THE INVENTION

The invention generally relates to distributed computing systems and more specifically to reducing undesirable communications in such systems.

### BACKGROUND OF THE INVENTION

Electronic messaging, particularly electronic mail (“e-mail”) is increasingly being used by commercial entities such as merchandisers to send unsolicited and unwanted advertisements. The mass mailing of such electronic messages is commonly known as “spam” and may constitute more than an annoyance. At billions of daily spams worldwide, these unwanted e-mails may increase infrastructure costs, interfere with productivity, and devalue the Internet.

A method for combating spam is to require an unknown sender to prove to a prospective recipient that it has expended computational effort for each message that it sends to the recipient. In this way, the sender of mass electronic messages may be deterred from sending messages to a recipient who requires such an effort. For example, the recipient may require a message to be accompanied by a correct evaluation of a specially chosen function, applied to suitable arguments. The cost to the sender of performing such an evaluation may be in terms of the time involved in such an effort. Additionally, the recipient may choose a function that is not amenable to amortization. In this way, for example, machines that send hundreds of thousands of spam messages each day may be able to only send eight thousand if the cost of sending each message is increased to 10 seconds. That is, the cost (in terms of computational effort) to the sender of sending 100 messages, for example, would be about 100 times the cost of sending one message.

Software operating on behalf of the recipient may then check that the evaluation of the function applied to suitable arguments has been properly computed. While the function may require effort for the sender to correctly evaluate, the evaluation may be relatively easy for the recipient to verify. If the evaluation is incorrect, then the accompanying message may be placed in a dedicated spam folder, may be subject to further filtering, or may be discarded.

Functions requiring such evaluation may be directed at a CPU of a sender's machine. CPU-bound functions, however, may suffer from a mismatch in processing speeds among different types of machines (e.g., the CPU speeds of a desktop machine versus a server, or a newer machine versus an older machine, may be different). In order to remedy disparities among computers for correctly evaluating the functions, the functions may be based in memory latency instead of CPU operations. Memory latencies may vary among differing computers less than CPU clock speeds and therefore, memory-bound functions may provide a more equitable burden than CPU-bound functions.

An algorithm for evaluating a function applied to suitable arguments may be memory-bound on a computer, effectively costing time in the form of memory cycles. Memory-bound functions may require a moderately large number of memory accesses and these accesses may be scattered. An example of a memory-bound function may be a cryptographic function, the arguments to which could include a message text, a recipient's name, and/or a date of a transmission of the message. The function additionally may include a hardness parameter related to a difficulty of correct evaluation such that, as the hardness parameter increases, more effort may be required to compute the proof.

The function may be associated with a large, fixed table of random integers. The table may be approximately twice as large as the largest caches and may dominate the space needs of such a memory-bound function. Evaluation of the function may force the e-mail sender to make a series of random accesses to the table, with each subsequent location in the table determined, in part, by the contents at a current location. In this way, a sender may be required to “walk through” the random table. The function may force the sender to explore many different paths through the table until a path with certain characteristics is found. Once a successful path has been identified, the sender includes information enabling the recipient to check that a successful path has been found with the e-mail message.

In 2003, Dwork et al. described a way to use such a table in conjunction with memory-bound functions (Cynthia Dwork et al., On Memory-Bound Functions For Fighting Spam, Advances in Cryptology, CRYPTO 2000, LNCS 2729, Springer, 2003, pp. 426-444). The solution described by Dwork et al. uses a large random, and thus incompressible, table of values. Thus, one problem associated with using a memory-bound function is that the associated random table may be large and incompressible. Downloading the table, therefore, may require an undesirable amount of time and may result in errors in the table during the downloading, causing problems in correctly evaluating a function applied to predetermined arguments. Therefore, there is a need for systems, methods, and tables to be used in association with performing computational effort on behalf of e-mail senders that do not consume an undesirable amount of time in downloading.

### SUMMARY OF THE INVENTION

An embodiment of the present invention is directed to a technique for constructing a large table from a description of a function. The description of the function may be downloaded onto an e-mail sender's computer, and then the function may be executed to build the table. The construction of the table may be memory-bound, and the table, once generated, may be used in performing a computational evaluation of a specially chosen function applied to suitable arguments. The results of the evaluation may then be sent to a prospective recipient of an e-mail.

The function for building the table may include initializing a table with initial values. The values may be 64 bit values, for example. A first hash function may be applied to each value, and then the table may be sorted. The hash function (or a different hash function) may be applied again to each value, and the table may be sorted again. This cycle may be repeated as many times as desired. At the conclusion of the hash-sort cycles, a final hash function, which may or may not be the same as the hash function previously used, may be applied to each value in the table. The final hash function may produce an unsorted table of values. The table may then be used in one or more function evaluations, and the evaluations may be sent along with an e-mail to a recipient. The recipient of the evaluation may then verify it and process the e-mail accordingly.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings example constructions of the invention; however, the invention is not limited to the specific methods and instrumentalities disclosed. In the drawings:

FIG. 1 is a block diagram of an example system in accordance with the present invention;

FIG. 2 is a flow diagram of an example method of routing a message in accordance with the present invention;

FIG. 3 is a flow diagram of an example method for generating a large table in accordance with an example embodiment of the invention; and

FIG. 4 is a block diagram showing an example computing environment in which aspects of the invention may be implemented.

### DETAILED DESCRIPTION OF ILLUSTRATIVE EMBODIMENTS

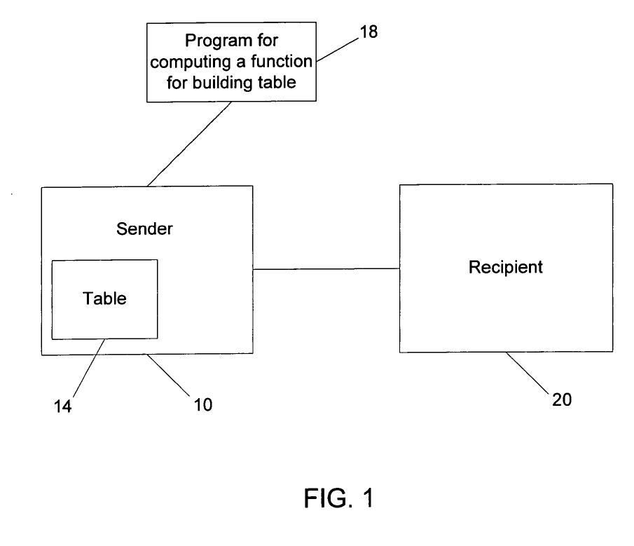

FIG. 1 is a block diagram of an example system in accordance with the present invention. A sender 10 of a message (e.g., an e-mail) desires to send the message to a recipient 20. The sender 10 provides an evaluation of a function applied to suitable arguments. The evaluation is desirably based on a memory-bound function, using a table 14 constructed via a memory-bound process. The table 14 is desirably built using a function provided by a program 18 that is downloaded by the sender 10, and is described further herein. The program 18 may be downloaded by the sender 10, for example, when the sender 10 first installs software containing an e-mail application. The table 14 additionally may be built at the time of installing an e-mail application and may be stored for future use. That is, the table 14 may be built once and may be used as part of proofs of computational effort until, for example, a developer of the e-mail application modifies the table 14 by, for example, increasing the table 14 size to match increasing cache sizes. In an alternative embodiment, the program 18 may reside in storage associated with the recipient 20 or elsewhere on a network, for example.

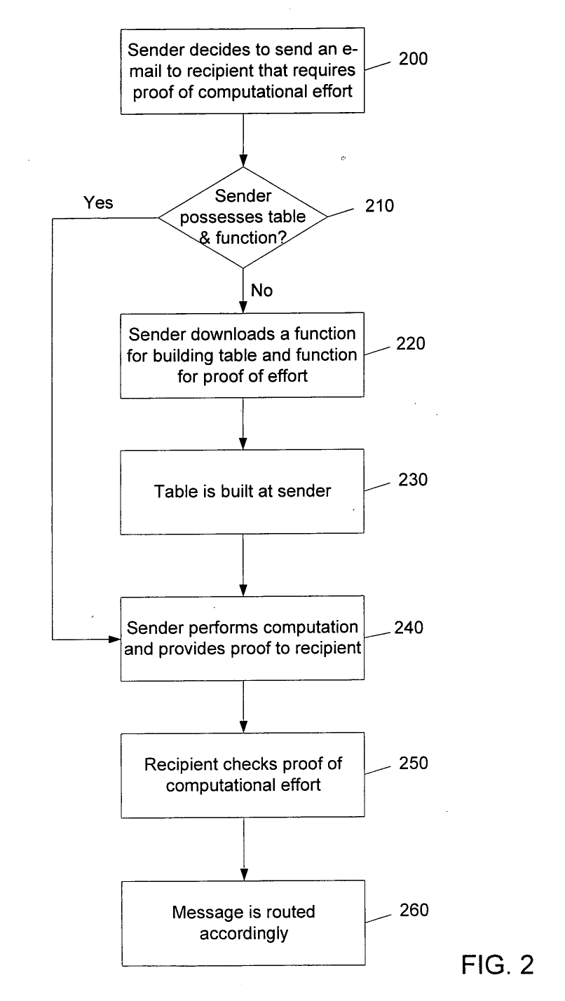

FIG. 2 is a flow diagram of an example method of routing a message in accordance with the present invention. At step 200, a sender decides to send an e-mail to a recipient who requires proof of computational effort. If at step 210, the e-mail sender does not possess a table constructed via a memory-bound process and a function for showing proof of computational effort, then the sender may download a function for building such a table and a function for showing proof of effort at step 220. At step 230, the sender may build the table. The sender, however, may already possess the table. A function or program describing the table may have been installed at the sender when the e-mail application was installed. The table may be built at the time of installation of the e-mail application for use by the sender for all e-mails involving a proof of computational effort.

The sender may next, at step 240, perform a computation using the table, and provide the results of the computation to the recipient. At step 250, the recipient may verify the computation. The verification may be completed by any suitable method. For example, the recipient may possess an identical table as the sender's table. Such a table may have been installed at the time of installation of the e-mail application, for example. Alternatively, the recipient may need a public verification key for a digital signature scheme, such signing key being held by a software manufacturer or standards body.

If the evaluation performed by the sender using the table is verified as correct by the recipient, then, at step 260, the message is routed accordingly. Such routing may include delivering the message to a predetermined mailbox (e.g., an inbox, a spam mailbox) associated with the recipient.

More particularly, using the table that has been built and verifying a sender's evaluation of a function using the table may proceed as set forth in Cynthia Dwork et al., On Memory-Bound Functions For Fighting Spam, Advances in Cryptology, CRYPTO 2000, LNCS 2729, Springer, 2003, pp. 426-444, herein incorporated by reference in its entirety.

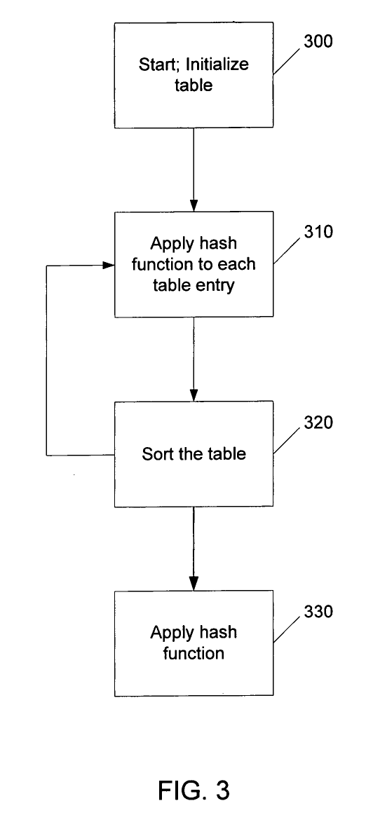

FIG. 3 is a flow diagram of an example method for generating a table in accordance with an example embodiment of the invention. Such a table may be associated with a memory-bound function requiring scattered memory accesses. The example method for generating the table may be, like the function associated with it, memory-bound.

At step 300, pursuant to the function that has been downloaded to the sender, a table T may be initialized and populated with integers, which may be in numerical order, such that the value T[i] at each table location i is equal to i. That is:
T[1]=1
T[2]=2
T[3]=3
. . .
T[n]=n
The value n, or the total number of table entries, may be set as large as desired and may be determined based on the size of the largest caches available (e.g., 32 MB or 64 MB). The value of n may be the size of the cache divided by a word size i (e.g., 32 bits or 64 bits).

At step 310, a hash function may be applied to each table entry such that the value in each entry becomes the hash h of the value i and the contents of the table T entry at i. That is:
T(i)=h[i, T(i)].
The hash function may be, for example, hmac-SHA 1, although any suitably strong hashing function may be used. Desirably, the low-order log(|T|) bits are used from the output of the hash, where |T| is the size of the table that is being built. Alternatively, a concatenation of the low-order log(|T|) bits and the index location of the bits in the table may be used from the output of the hash.

At step 320, the table may be sorted in a predefined manner, resulting in a new definition of the table. Sorting algorithms may be well known to those skilled in the art, and any common library routine for sorting may be used.

Steps 310 and 320 may be repeated, that is, iterated may times, and the hash function or sorting algorithm applied each time may be the same or may be different. The number of times that the hash function is applied and the table is sorted may be predetermined and may be established by, for example, a developer of the function describing the table, which may be a developer of an e-mail application associated with the table. Alternatively, the number of times that the hash function and sorting algorithm are applied may be determined by a standards body. Generally, increasing the number of iterations may make it less likely that the sender of an e-mail, for example, may find a faster than desired method to evaluate a memory bound function and show proof of computational effort. At step 330, a hash function may again be applied to each entry of the table, and is desirably similar to the hash function used in step 310. This desirably results in an unsorted table T of values, which may then be used in performing the computational effort for the proof that is to be provided to the recipient. It is contemplated that the hash function applied in step 330 may be the same as or different than the hash function applied in step 310.

Thus, a table may be constructed via a memory bound process, based on a function for building the table that is downloaded by the sender. Thus, the sender does not have to download the table itself, but instead downloads a short description of the function for building the table. This table may then be used in accordance with previous known processing techniques (e.g., those described in Cynthia Dwork et al., On Memory-Bound Functions For Fighting Spam, Advances in Cryptology, CRYPTO 2000, LNCS 2729, Springer, 2003, pp. 426-444).

Example Computing Environment

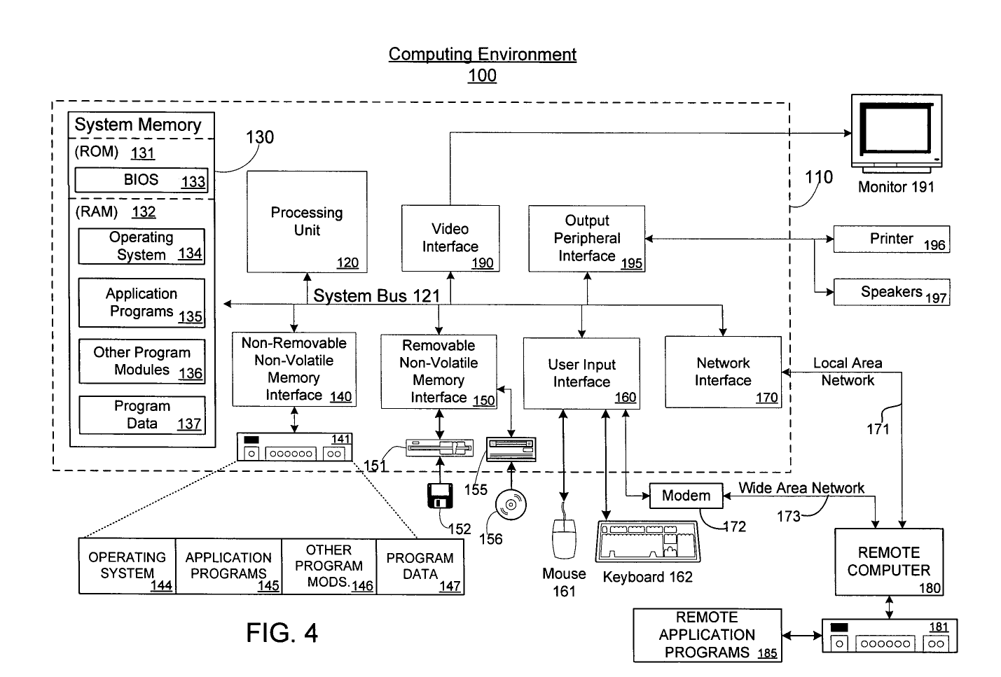

FIG. 4 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 4 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the example operating environment 100.

With reference to FIG. 4, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system memory 130 may include cache memory. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 4 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 4 provide storage of computer readable instructions, data structures, program modules and other data for the computer 110. In FIG. 4, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are examples and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

What is claimed:

1. A method for generating a table of entries, each entry comprising an initial value, the method comprising:
applying a first hash function to the initial value of each entry in the table resulting in each entry comprising a first hashed value comprising a set of bits; and
sorting the table, wherein the method is memory bound.

2. The method of claim 1, further comprising:
determining for each entry a subset S of bits of the set of bits of the first hashed value;
applying a second hash function to each subset S of bits resulting in a hashed subset S of bits value for each entry; and
substituting the first hashed value with the hashed subset S of bits value for each entry, wherein each subset S of bits is smaller than the set of bits of the first hashed value.

3. The method of claim 2, wherein the table comprises a total number of entries and the subset S of bits comprises a low order K bits, wherein K is equal to one plus a value of the base 2 logarithm of the total number of entries, rounded up to the nearest integer.

4. The method of claim 1, further comprising:
determining for each entry a subset S of bits of the set of bits of the first hashed value;
determining for each entry a numerical location of the entry in the table;
applying a second hash function to a concatenation of each subset S of bits and its numerical location in the table, resulting in a concatenation value for each entry; and
substituting the first hashed value with the concatenation value for each entry, wherein each subset of bits is smaller than the set of bits.

5. The method of claim 1, further comprising:
applying a second hash function to each first hashed value in the table resulting in a table of second hashed values; and
sorting the table of second hashed values, wherein applying the second hash function and sorting the table of second hashed values are performed a predetermined number of times.

6. The method of claim 5, wherein the first and second hash functions are substantially identical.

7. The method of claim 1, further comprising:
initializing the table to assign each entry with the initial value.

8. The method of claim 7, wherein each entry has a numerical location in the table and initializing the table comprises setting the initial value of each entry to be equal to the numerical location of the entry.

9. The method of claim 1, wherein the first hash function comprises a hmac-SHA 1 hash function.

10. The method of claim 1, wherein the value of each entry comprises a 64-bit word.

11. A computer-readable medium having computer-executable instructions for performing steps, comprising:
applying a first hash function to each of a plurality of initial values in a table resulting in the table comprising first hashed values, wherein each first hashed value comprises a set of bits; and
sorting the table, wherein applying the first hash function and sorting the table are memory bound.

12. The computer-readable medium of claim 11, having further computer-executable instructions for performing the steps of:
determining for each first hashed value a subset S of bits of the set of bits;
applying a second hash function to each subset S of bits resulting in a hashed subset S of bits value for each subset S of bits; and
substituting each first hashed value with the hashed subset S of bits value.

13. The computer-readable medium of claim 11, having further computer-executable instructions for performing the step of:
applying a second hash function to each first hashed value in the table resulting in a table of second hashed values; and
sorting the table of second hashed values, wherein applying the second hash function and sorting the table of second hashed values are performed a predetermined number of times.

14. A system for generating a table of entries, each entry comprising an initial value, the system comprising:
means for applying a first hash function to the initial value of each entry in the table resulting in each entry comprising a first hashed value comprising a set of bits; and
means for sorting the table, wherein applying the first hash function and sorting the table are memory bound.

15. The system of claim 14, further comprising:
means for determining for each entry a subset S of bits of the set of bits of the first hashed value;
means for applying a second hash function to each subset S of bits resulting in a hashed subset S of bits value for each entry; and
means for substituting the first hashed value with the hashed subset S of bits value, wherein each subset S of bits is smaller than the set of bits.

16. The system of claim 15, wherein the table comprises a total number of entries and the subset S of bits comprises a low order K bits, wherein K is an integer equal to one plus a value of the base 2 logarithm of the total number of entries, rounded up to the nearest integer.

17. The system of claim 14, further comprising:
means for applying a second hash function to each first hashed value in the table resulting in a table of second hashed values; and
means for sorting the table of second hashed values, wherein applying the second hash function and sorting the table of second hashed values are performed a predetermined number of times.

18. The system of claim 17, wherein the first and second hash functions are substantially identical.

19. The system of claim 14, further comprising:
means for initializing the table to assign each entry with the initial value.

20. The system of claim 14, wherein the table is used in evaluating a memory bound function.
